(19) United States
(12) Patent Application Publication
(10) Pub. No.: US 2013/0177316 A1
(43) Pub. Date: Jul. 11, 2013

(54) OPTICAL COMMUNICATION SYSTEM, AND TRANSMITTER AND RECEIVER APPARATUS THEREFOR

(71) Applicant: Mustafa Cardakli, San Ramon, CA (US)

(72) Inventor: Mustafa Cardakli, San Ramon, CA (US)

(73) Assignee: Emcore Corporation, Albuquerque, NM (US)

(21) Appl. No.: 13/345,213

(22) Filed: Jan. 6, 2012

(51) Int. Cl. H04J 14/02; H04B 10/06; H04B 10/04

(52) U.S. Cl. 398/79; 398/184; 398/208

(57) ABSTRACT

An optical communication system having a transmitter in which a pair of optical signals having different frequencies are modulated using a duobinary encoding scheme, and then multiplexed using polarization division multiplexing. Advantageously, the frequency difference between the two signals can be less than the data rate conveyed by each signal, resulting in a narrow spectral bandwidth, while still allowing demultiplexing at a receiver using simple bandpass filters and without the need of any form of polarization tracking. A receiver has a beam splitter for splitting the received optical signal into two portions which are each directed, via respective bandpass filters centred at slightly different frequencies, to respective detectors. Advantageously, the frequency difference between the frequencies at which the bandpass filters are centred can be less than the data rate of a detected signal. The receiver does not require any polarization tracking or balancing, and accordingly is straightforward to implement

[symbol]

### BACKGROUND OF THE INVENTION

1. Field of the Invention

The present invention relates to an optical communication system in which an optical beam is modulated in accordance with data in a transmitter, and the modulated optical beam is then transmitted to a remote receiver which recovers the data. The invention has particular, but not exclusive, application to a so-called 40G optical communication network at which data is communicated along a data pipe at a rate of 40 Gigabits per second (Gbps) or more.

2. The Background Art

In recent years, the need to increase data rates in optical communication to the benchmark figures of 40 Gbps and 100 Gbps has prompted much research. One problem with increasing data rates is the consequent increase in frequency bandwidth, which is problematic due to increased dispersion in optical fibers and also because an increase in frequency bandwidth requires a greater frequency spacing of data channels in a wavelength division multiplexing (WDM) system.

The use of optical duobinary modulation, in which a data signal is added to a one-bit delayed version of itself to generate a three level signal, has attracted attention due to its narrow bandwidth in comparison with a binary non-return-to-zero (NRZ) modulated signal. In practice, optical duobinary modulation typically employs a precoder to perform differential encoding in order to prevent error propagation. In order to maintain the bandwidth advantage when using such a precoder, one binary logic level output by the precoder is converted to a low amplitude state of the optical signal while the other binary logic level output by the precoder is converted to high amplitude states of the optical signal having opposite phases. At the receiver, conveniently the low amplitude state is converted to one binary logic value while both the high amplitude states are converted to the other binary logic value to recover the original data signal.

Other modulation techniques deployed include phase-shift keying (DPSK) and quadrature phase shift keying (QPSK), particularly in differential format. In addition, polarization division multiplexing has been used to further increase the data rates by employing two optical signals at the same frequency but with orthogonal polarizations. Polarization division multiplexing typically requires, however, a complex receiver due to the difficulty in separating the two optical signals at the receiver with acceptable levels of crosstalk.

### SUMMARY OF THE INVENTION

One aspect of the present invention provides for a transmitter in which a pair of optical signals having different frequencies are modulated using a duobinary encoding scheme, and then multiplexed using polarization division multiplexing. Advantageously, the frequency difference between the two signals can be less than the data rate conveyed by each signal, resulting in a narrow spectral bandwidth, while still allowing demultiplexing at a receiver using simple bandpass filters and without the need of any form of polarization tracking.

Another aspect of the invention provides for a receiver having a wavelength-dependent beam splitter arrangement for splitting a received optical signal into two portions which are each directed to respective detectors. A first spectral component at a first frequency is preferentially split into the first portion, and a second spectral component at a second frequency is preferentially split into the second portion. Advantageously, the frequency difference between the first and second frequencies can be less than the data rate of a detected signal. The receiver does not require any polarization tracking or balancing, and accordingly is straightforward to implement.

A further aspect of the invention provides a Dense Wavelength Division Multiplexing (DWDM) optical communication system in which a plurality of transmitters generate a modulated optical signal by using polarization division modulation to combine two optical signals at slightly different frequencies, modulated in accordance with a duobinary encoding scheme, to generate respective optical data signals. The optical data signals are combined using wavelength division multiplexing, and transmitted over an optical fibre to a demultiplexer which demultiplexes the optical data signals. Each optical data signal is then split into two portions, and each portion is directed via a respective bandpass filter to a respective detector.

### BRIEF DESCRIPTION OF THE DRAWINGS

FIG. 1 is a block diagram showing the main components of an optical communication system forming a preferred embodiment of the invention;

FIG. 2 is a graph showing the variation of electric field for an optical signal output by a Mach-Zehnder modulator with variation of an applied electrical potential;

FIG. 3 is a graph showing an exemplary waveform input into a low pass filter forming part of a transmitter of the optical communication system of FIG. 1;

FIG. 4 is a graph showing the waveform output by the low-pass filter in response to the exemplary input waveform illustrated in FIG. 3;

FIG. 5 is a graph showing an exemplary frequency spectrum of the output of a transmitter of the optical communication system illustrated in FIG. 1;

FIG. 6 is a graph showing transmissivity against frequency for a bandpass filter in a receiver forming part of the optical communication system illustrated in FIG. 1;

FIG. 7 is a block diagram showing the main components of a first alternative receiver for the optical communication system illustrated in FIG. 1;

FIG. 8 is a block diagram showing the main components of a second alternative receiver for the optical communication system illustrated in FIG. 1; and

FIG. 9 is a block diagram of a DWDM optical communication system including optical communication in accordance with the present invention.

### DESCRIPTION OF THE PREFERRED EMBODIMENT

Details of the present invention will now be described, including exemplary aspects and embodiments thereof. Referring to the drawings and the following description, like reference numbers are used to identify like or functionally similar elements, and are intended to illustrate major features of exemplary embodiments in a highly simplified diagrammatic manner. Moreover, the drawings are not intended to depict every feature of actual embodiments nor the relative dimensions of the depicted elements, and are not drawn to scale.

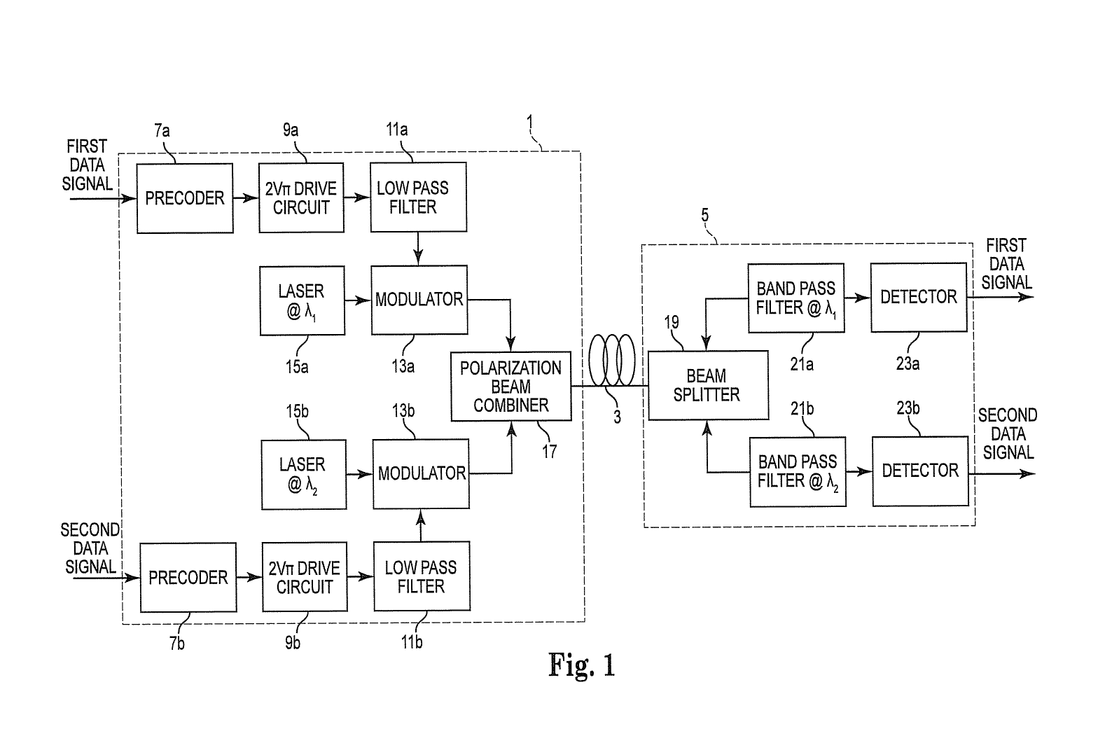

As shown in FIG. 1, in an optical communication system according to the present invention a transmitter 1 transmits a modulated optical signal through an optical fiber 3 to a receiver 5. The optical signal is modulated in accordance with first and second data signals which are input to respective precoders 7a, 7b of the transmitter 1. In this embodiment, each data signal conveys data serially at a data rate of 22 Gigabits per second (Gbps). The pair of data signals may be formed from a single data signal at 44 Gbps.

Each of the precoders 7 performs differential encoding. In particular, in each precoder the input data signal is inverted and then input into one input of an exclusive-OR gate, and the output of the exclusive-OR gate for each clock cycle is input into the other input of the exclusive-OR gate for the following clock cycle. The output of the exclusive-OR gate also forms the output of the precoder 7.

The output of each precoder 7a, 7b is input to a respective 2V_{π} drive circuit 9a, 9b, with each 2V_{π} drive circuit 9 applying control voltages to a corresponding Mach-Zehnder modulator 13. As those skilled in the art will appreciate, a Mach-Zehnder modulator splits a received coherent optical signal into two light beams which are directed through respective arms of the Mach-Zehnder modulator and then recombined. A variable optical path difference is introduced into one or both of the light paths in order to vary the amplitude of the recombined optical signal.

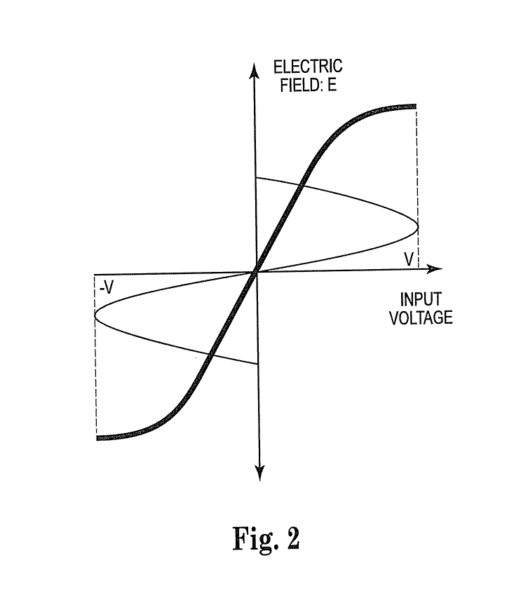

In this embodiment, each 2V_{π}, drive circuit 9 has a pair of V_{π} drive circuits, with the output of each V_{π} drive circuit being input, via a respective low-pass filter 11, to an electrode associated with a respective arm of corresponding Mach-Zehnder modulator (MZM) 13. One of the V_{π} drive circuits is driven by the output of the corresponding precoder 7 while the other of the V_{π} drive circuits is driven by the inverse of the output of the corresponding precoder 7 so that differential driving is performed. Each Mach-Zehnder modulator 13 is biased at a level where the optical path difference between the two paths is 180°, resulting in a null output as the light travelling down one path destructively interferes with the light travelling down the other path. The 2V_{π} drive circuits 9 are configured such that a potential difference of amplitude V is applied across the electrodes associated with the arms of the MZM 13, with the polarity of the applied voltage dependent on the binary logic level output by the corresponding precoder 7. The application of the potential difference V with one polarity results in a maximum amplitude of the recombined optical signal output by the MZM 13 with a first phase while the application of the potential difference V with the other polarity results in a maximum amplitude of the recombined optical signal output by the MZM 13 at a second phase which is 180° out of phase with the first phase. In other words, as illustrated in FIG. 2, the electric field strengths E of the recombined optical signal output by the MZM 13 when the potential difference V is applied with opposite polarities are of equal amplitude but opposite sign.

The low-pass filters 11 are configured such that the output of each low-pass filter 11 substantially corresponds to the average of the voltage levels output by the corresponding 2V_{π} drive circuit 9 for the last two data bits. Accordingly, if the output of a V_{π} drive circuit 9 corresponds to a sequence of two different bits, then the voltage output by the low-pass filter is effectively zero, whereas if the two bits are the same then the voltage output by the low pass filter corresponds to the input voltage. This is a conventional way of implementing a duobinary encoding scheme.

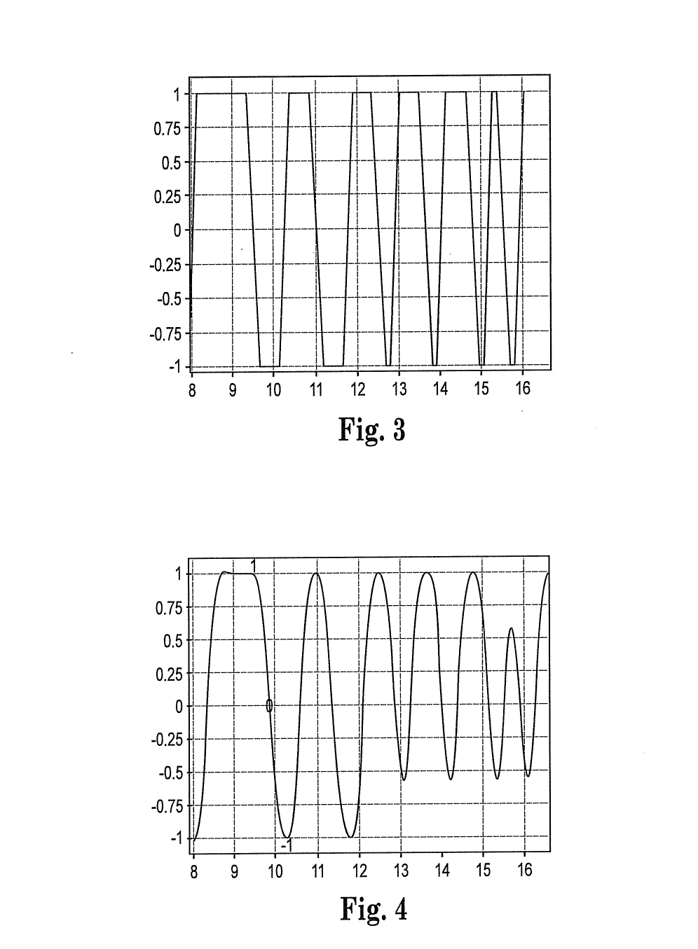

In this embodiment, the low-pass filters 11 are 5^{th} order Bessel filters which provide a substantially flat group delay up to 13.4 GHz. FIGS. 3 and 4 respectively show an exemplary input to a low-pass filter 11 and the corresponding output of the low-pass filter 11.

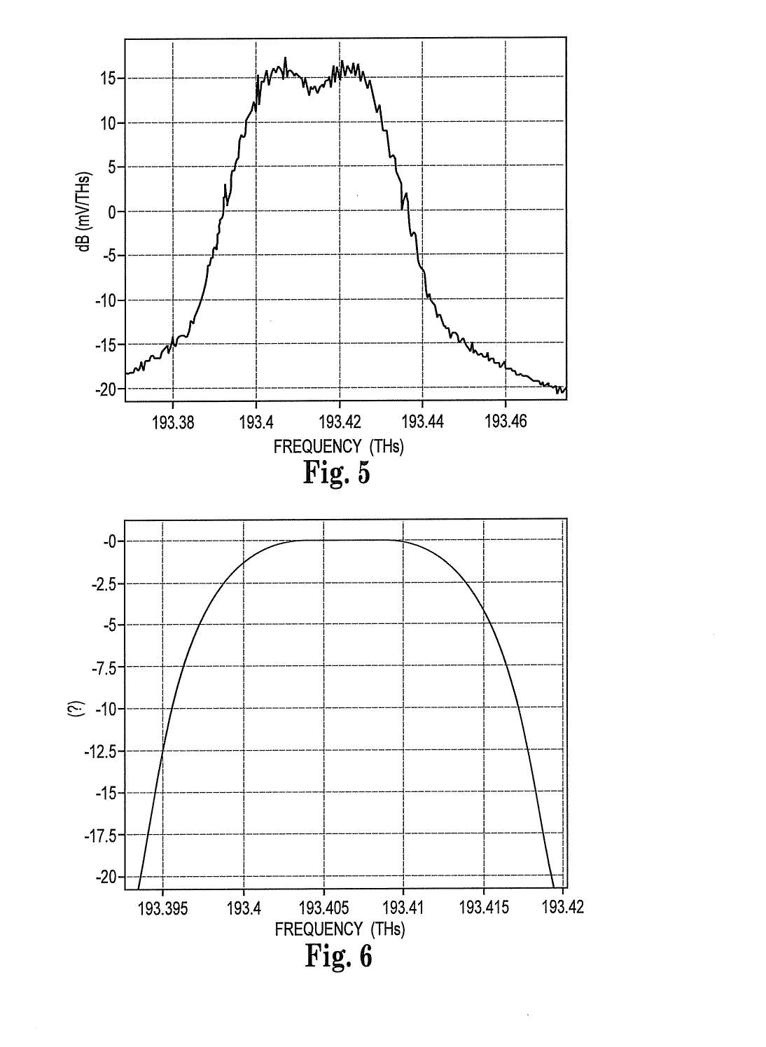

First and second lasers 15a, 15b output coherent light beams which are input to respective ones of the modulators 13a, 13b. In this embodiment, the first laser 15a outputs a coherent optical beam at a first wavelength λ₁ and the second laser 15b outputs a coherent light beam at a second wavelength λ₂, with the frequency difference between the two laser equal to 16 GHz. This frequency difference is therefore less than the data rate of one of the data signals. Further, the outputs of the first and second lasers 15a, 15b have linear polarizations which are mutually orthogonal to each other. A polarization beam combiner 17 combines the two outputs of the MZMs to form the output signal of the transmitter 1, and this output signal is coupled into the optical fibre 3. The different polarization states of the outputs of the MZMs reduces interference between the data of the first and second data signals. FIG. 5 shows the frequency spectrum of an exemplary output of the transmitter 1. It will be seen that there are two local maxima, which correspond to the wavelengths of the first and second lasers 9.

Table 1 illustrates states of the transmitter 1 for an exemplary data string.

TABLE 1
States of components of the transmitter
1 for an exemplary data string.

| Clock Cycle | −1 | 0 | 1 | 2 | 3 | 4 | 5 |
|---|---|---|---|---|---|---|---|
| Data | | 0 | 1 | 0 | 1 | 1 | 1 |
| Precoder Output | 0 | 1 | 1 | 0 | 0 | 0 | 0 |
| Drive Circuit Output | −V | V | V | −V | −V | −V | −V |
| Low-pass Filter Output | | 0 | V | 0 | −V | −V | −V |
| MZM Output | | 0 | E | 0 | −E | −E | −E |

In table 1 it will be seem that the output of the MZM 13 corresponds to a duobinary encoded version of the data signal in which the binary logic state “1” is represented by an electric field amplitude E at two phases which are 180° out of phase with each other. Accordingly, a spectral component at wavelength λ₁ is modulated in accordance with the first data signal and a spectral component at wavelength λ₂ is modulated in accordance with the second data signal. At the receiver, a data signal can be recovered simply by detecting the amplitude of the electric field strength at the corresponding wavelength.

Returning to FIG. 1, after passing through the optical fiber 3, the signal output by the transmitter 1 is input to the receiver 5 where it is split into two equal portions by a beam splitter 19. In this embodiment, the beam splitter 19 is wavelength insensitive so that the spectral distributions of each of the split portions are the same. One split portion is input to a first bandpass filter 21a and the other split portion is input to a second bandpass filter 21b. The first bandpass filter 21a is centred at λ₁ while the second bandpass filter 21b is centred at λ₂. The first and second bandpass filters 21a,21b both have a 3 dB bandwidth of 16 GHz, so that light transmitted by the first bandpass filter 21a generally originates from the first laser 15a and light transmitted by the second bandpass filter 21b generally originates from the second laser 15b. FIG. 6 illustrated how the transmissivity of a bandpass filter 21 varies with frequency.

The light transmitted by the first bandpass filter 21a is detected by a first detector 23a to recover the first data signal and the light transmitted by the second bandpass filter 21b is detected by a second detector 23b to recover the second data signal.

It will be appreciated that the light output from each bandpass filter 21 could be amplified using an optical amplifier prior to detection.

In an embodiment, the components of the transmitter 1 are formed in an integrated optical circuit, and similarly the components of the detector 5 are formed in an integrated optical circuit.

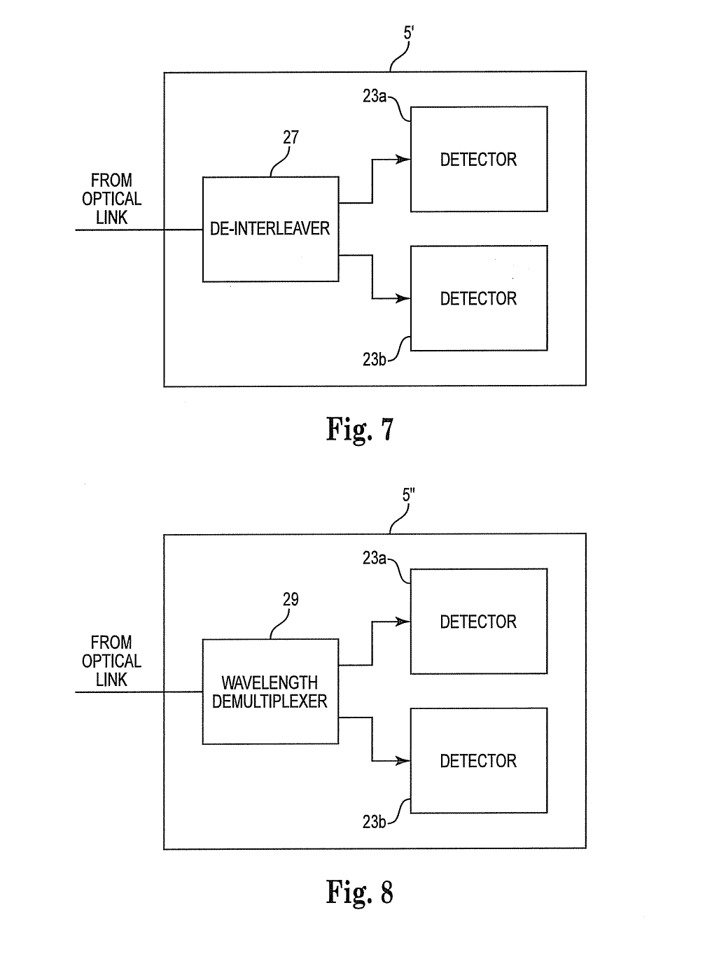

In the receiver 5 discussed above, the beam splitter 19 and the first and second bandpass filters 21a,21b form a wavelength-dependent beam splitting arrangement. Other forms of wavelength-dependent beam splitting arrangements are possible. For example, as shown in FIG. 7, in an alternative embodiment a receiver 5′ has a wavelength-dependent beam splitter arrangement in the form of an optical de-interleaves 27 which directs a first optical signal predominantly comprising a first spectral component to a first detector 23a and a second optical signal predominantly comprising a second spectral component to a second detector 23b. More generally, as shown in FIG. 8, in an embodiment a receiver 5″ has a wavelength-dependent beam splitter arrangement in the form of a wavelength demultiplexer 29.

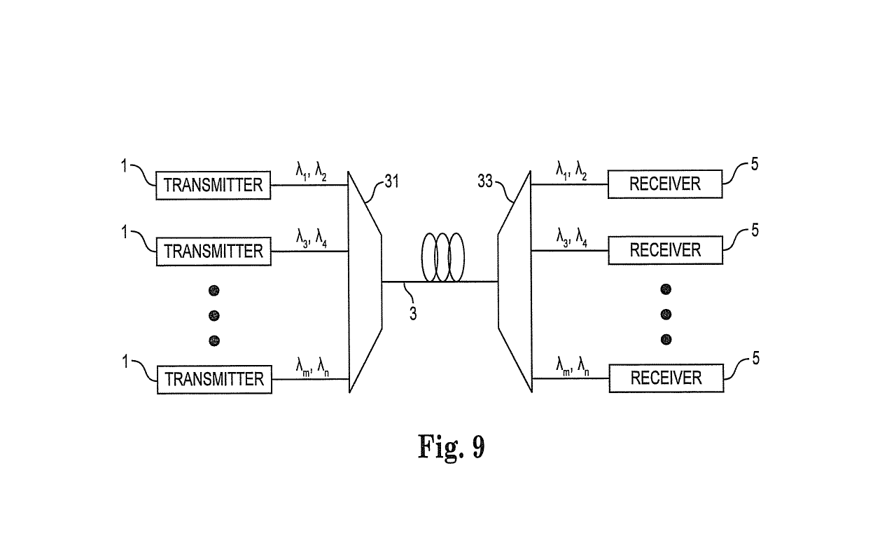

Due to the narrow bandwidths of the transmitted optical signals, transmitters and receivers according to the present invention are well suited to a DWDM optical communication system. In a DWDM, multiple channels at different wavelength are multiplexed into a single fiber communications window, usually the window around 1550 nm to take advantage of the devices available at that wavelength. As shown in FIG. 9, a plurality of transmitters as described above each output an optical signal having two components centred at slightly different frequencies, with the frequencies used in one transmitter 1 being spaced from the frequencies used in all the other transmitters 1. The output signals are input to a wavelength multiplexer 31 which combines the output signals, and the combined output signal is transmitted through the optical fiber 3. Following transmission through the optical fiber 3, the transmitted signal is demultiplexed by the wavelength demultiplexer 33 to recover the optical signals having two components at slightly different frequencies, and these optical signals are input into respective receivers 5 as described above.

In the embodiment illustrated in FIG. 1, two lasers 9a, 9b are used having orthogonal linear polarizations. It will be appreciated that differences in the polarization state could be used, for example orthogonal circular polarizations. Alternatively, two lasers emitting light beams having identical polarizations could be used, with the polarization state of one light beam being altered prior to combining with the other light beam in the polarization beam combiner. It will be further appreciated that a single laser can be used to generate two light beams at slightly different frequencies.

1. A transmitter comprising:
a first light source for generating a first coherent light beam at a first frequency;
a first encoder for encoding a first data signal using a duobinary encoding scheme to generate a first encoded signal;
a first modulator for modulating the first coherent light beam in accordance with the first encoded signal to generate a first modulated light beam, wherein the first modulated light beam has a first polarization state;
a second light source for generating a second coherent light beam at a second frequency different from the first frequency;
a second encoder for encoding a second data signal using a duobinary encoding scheme to generate a second encoded signal;
a second modulator for modulating the second coherent light beam in accordance with the first second encoded signal to generate a second modulated light beam, wherein the second modulated light beam has a second polarization state that is different from the first polarization state; and
a combiner arranged to combine the first modulated light beam and the second modulated light beam for form a combined light beam for output to a communication channel.

2. A transmitter according to claim 1, wherein the first and second data signals have a data rate which is greater then a frequency difference between the first frequency and the second frequency.

3. A transmitter according to claim 1, wherein the first encoder and the second encoder comprises:
a precoder for differentially encoding the first data signal to generate a differential signal;
a drive circuit for generating a drive signal in dependence on the differential signal; and
a low pass filter for filtering the drive signal to generate a duobinary drive signal.

4. A transmitter according to claim 3, wherein the precoder comprises:
an inverter for inverting the first data signal to generate an inverted data signal; and
a logic gate for performing an exclusive-OR logic function on the inverted data signal and a feedback data signal to generate an output signal, the feedback data signal corresponding to a time-delayed version of the output signal.

5. A transmitter according to claim 3, wherein the low pass filter is a fifth order Bessel filter.

6. A transmitter according to claim 1, wherein one or both of the first modulator and the second modulator comprises a Mach Zehnder modulator.

7. A transmitter according to claim 1, wherein the first polarization state and the second polarization state are linear polarization states which are orthogonal to each other.

8. A transmitter according to claim 1, wherein the combiner is a polarization beam combiner.

9. A transmitter according to claim 1, wherein the first frequency and the second frequency are 20 GHz or more.

10. A transmitter according to claim 9, wherein a frequency difference between the first frequency and the second frequency is less than 20 GHz.

11. A receiver comprising:
a wavelength-dependent beam splitter arrangement operable to split a received optical signal, which is modulated in accordance with a data signal and has a first spectral component centred at a first frequency and a second spectral component centred at a second frequency different from the first frequency, into a first optical signal and a second optical signal, wherein the first optical signal comprises more of the first spectral component than the second spectral component and the second optical signal comprises more of the second spectral component than the first spectral component;
a first detector for detecting the first optical signal; and
a second detector for detecting the second optical signal,
wherein the first detector and the second detector are operable to detect a data signal having a data rate that is greater than the frequency difference between the first frequency and the second frequency.

12. A receiver according to claim 11, wherein the wavelength-dependent beam splitter arrangement comprises:
a beam splitter operable to split the received optical signal into a first split optical signal and a second split optical signal;
a first bandpass filter operable to filter the first split optical signal to form the first optical signal, the first bandpass filter being centred at the first frequency; and
a second bandpass filter operable to filter the second split optical signal to form the second optical signal, the second bandpass filter being centred at the second frequency.

13. A receiver according to claim 12, wherein the first bandpass filter and the second bandpass filter have a 3 dB bandwidth corresponding to the frequency difference between the first frequency and the second frequency.

14. A receiver according to claim 11, wherein the wavelength-dependent beam splitter arrangement comprises an optical de-interleaver.

15. A receiver according to claim 11, wherein the wavelength-dependent beam splitter arrangement comprises a wavelength demultiplexer.

16. A receiver according to claim 11, wherein the first detector and the second detector are operable to detect a data signal having a data rate of 20 GHz or more.

17. A receiver according to claim 11, wherein the frequency difference between the first frequency and the second frequency is less than 20 GHz.

18. An optical communication system comprising:
a plurality of transmitters for generating modulated optical signals, each modulated optical signal being centred at a respective different optical frequency;
a multiplexer for multiplexing said modulated optical signals for simultaneous transmission over an optical communication link;
a demultiplexer for demultiplexing said modulated optical signals following transmission over the optical communication link; and
a plurality of receivers for detecting the modulated optical signals,
wherein each transmitter is arranged to generate a pair of duobinary modulated optical signals centred at respective optical frequencies separated by less than the data rate of each of the pair of duobinary modulated optical signals.
